(19) United States
(12) Patent Application Publication
(10) Pub. No.: US 2006/0055278 A1
(43) Pub. Date: Mar. 16, 2006

(54) Step motor having stator with separated structure

(75) Inventor: Rong-Bin Zhou, Dong-Guan City (CN)

Correspondence Address: MERCHANT & GOULD PC, P.O. BOX 2903, MINNEAPOLIS, MN, 55402-0903, US

(73) Assignee: ASIA OPTICAL CO., INC., Taichung (TW)

(21) Appl. No.: 11/172,724

(22) Filed: Jun. 30, 2005

(30) Foreign Application Priority Data
Sep. 14, 2004 (TW) 093127735

(51) Int. Cl. H02K 37/00; H02K 37/14; H02K 1/12

(52) U.S. Cl. 310/257; 310/49 A; 310/49 R

(57) ABSTRACT

A step motor includes a spindle, a magnet unit mounted around the spindle, and a stator assembly sleeved over the magnet unit. The stator assembly includes at least one coil-and-yoke unit having a coil support, a coil wound around the coil support, an outer tube sleeved over the coil, and a pair of magnetic yokes mounted in the coil support. A fixing plate and a cover unit are mounted to opposite ends of the stator assembly. The coil support includes a surrounding wall, and a positioning tab protruding from the surrounding wall. Notches are formed in the outer tube, and the positioning tab engages one of the notches. Each of the magnetic yokes includes an orientation fixing member that engages one of the notches, and a plurality of excitation fingers inserted into the coil support and circumferentially uniformly distributed.

### CROSS-REFERENCE TO RELATED APPLICATION

This application claims priority of Taiwanese Application No. 093127735, filed on Sep. 14, 2004.

### BACKGROUND OF THE INVENTION

1. Field of the Invention

The present invention relates to a step motor, more particularly to a step motor having a stator with a separated structure.

2. Description of the Related Art

FIG. 1 shows a conventional step motor, in which magnetic yokes and coil supports of a stator are integrally connected. In more detail, the stator includes at least a pair of magnetic yokes 1, each mounted in opposition to another one of the magnetic yokes 1 and centered about a motor axis, a pair of coil supports 2 covering respectively outer surfaces of the magnetic yokes 1, and coil members 3 wound respectively around the coil supports 2.

Manufacture of the stator involves first assembling the magnetic yokes 1, then placing the assembled magnetic yokes 1 in a mold to form the coil supports 2 using a plastic material. Such a process is complicated and involves high costs. In addition, the mold itself needs to be designed and produced, further increasing overall complexity and manufacturing costs.

FIGS. 2 and 3 show another conventional stator for a step motor, in which magnetic yokes and outer cylinders are integrally formed. In more detail, the stator includes a pair of coil supports 4, a pair of coils 5 wound respectively around the coil supports 4, two pairs of magnetic yokes 6, and a pair of outer cylinders 7 mounted around the coil supports 4. The innermost two magnetic yokes 6 are inserted respectively into the coil supports 4, whereas the outermost two magnetic yokes 6 are formed integrally and respectively with the outer cylinders 7.

Although this structure allows for direct assembly of the stator that does not involve molding processes, since the outermost pair of the magnetic yokes 6 and the outer cylinders 7 have an integral structure, and the resulting cross section of the integrated magnetic yokes 6 and outer cylinders 7 is U-shaped (see FIG. 3), performing drawing processes for forming these integral elements is difficult. Furthermore, finishing processes are typically performed following drawing to obtain a more precise ratio between a sectional area and a length of excitation fingers 601 of the magnetic yokes 6. The integral structure makes the finishing processes difficult to perform.

### SUMMARY OF THE INVENTION

The object of this invention is to provide a step motor with a separated stator structure, in which an insertion/sleeved configuration is used to realize secure and simple assembly between magnetic yokes and coil supports of the stator.

The step motor of this invention comprises: a spindle that extends along a motor axis; a magnet unit mounted around the spindle; a stator assembly sleeved over the magnet unit and having opposite ends, and including at least one coil-and-yoke unit having a coil support, a coil wound around the coil support, an outer tube sleeved over the coil, and a pair of magnetic yokes mounted in the coil support; a fixing plate mounted to one of the ends of the stator assembly, and in which the spindle is journalled; and a cover unit mounted to the other one of the ends of the stator assembly opposite to the fixing plate, and in which an end portion of the spindle is journalled.

The coil support includes a surrounding wall surrounding the motor axis, and a positioning tab protruding outwardly from the surrounding wall. The outer tube includes first and second end portions, first and second catch notches formed respectively in the first and second end portions, and a positioning notch formed in one of the first and second end portions to engage the positioning tab of the coil support. Each of the magnetic yokes includes an orientation fixing member, and a plurality of excitation fingers inserted into the surrounding wall of the coil support. The orientation fixing member of each of the magnetic yokes engages a respective one of the first and second catch notches, and the excitation fingers of the magnetic yokes are uniformly distributed about the motor axis.

### BRIEF DESCRIPTION OF THE DRAWINGS

Other features and advantages of the present invention will become apparent in the following detailed description of the preferred embodiment with reference to the accompanying drawings, of which:

FIG. 1 is a sectional view of a conventional step motor, in which magnetic yokes and coil supports of a stator are integrally formed;

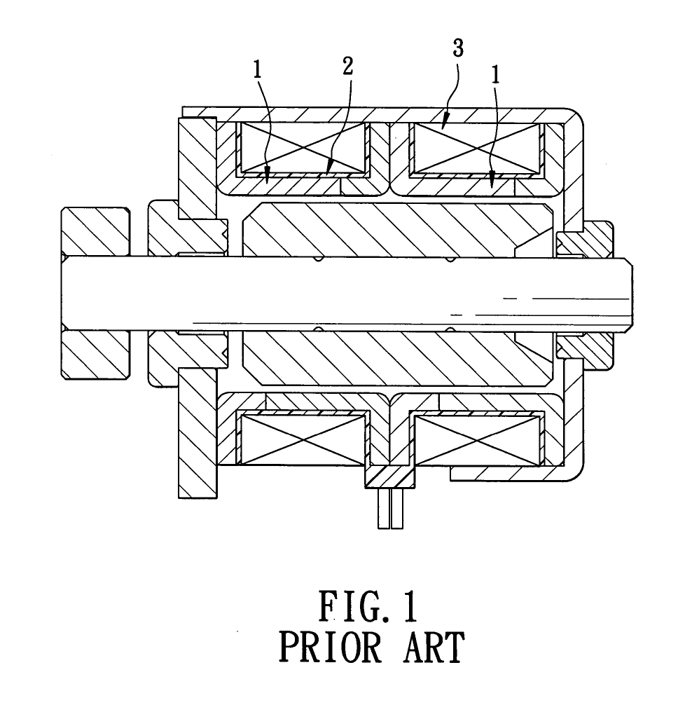

FIG. 2 is an exploded perspective view of a conventional stator, in which magnetic yokes and outer cylinders are integrally formed;

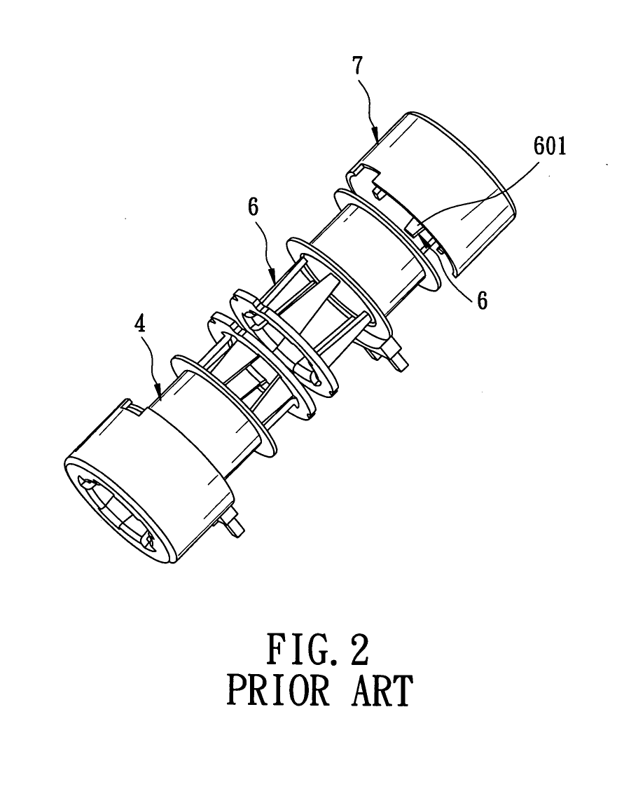

FIG. 3 is an assembled sectional view of a step motor utilizing the stator of FIG. 2;

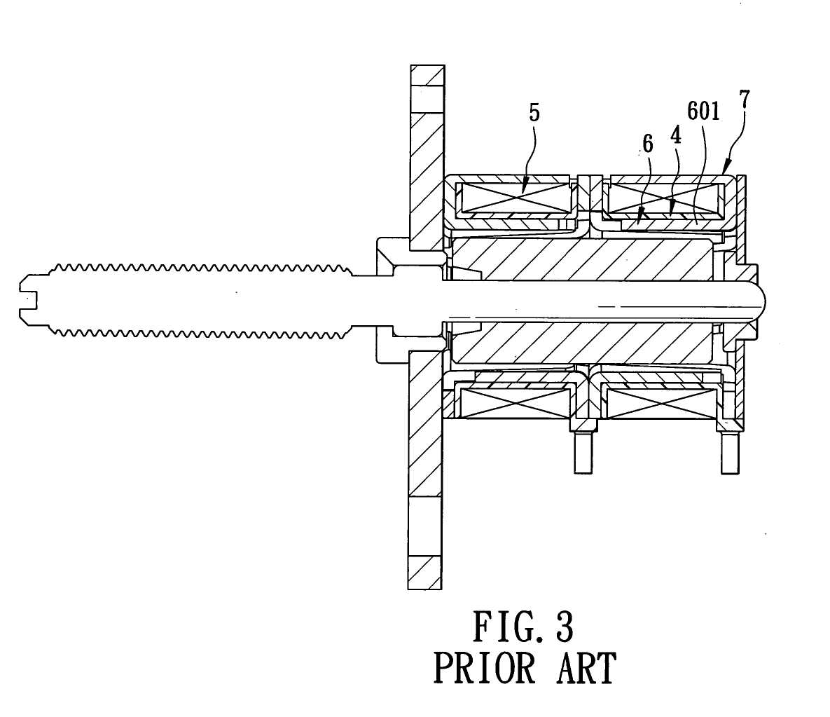

FIG. 4 is an exploded perspective view of a step motor having a stator with a separated structure according to a preferred embodiment of the present invention;

FIG. 5 is an assembled perspective view of the step motor of FIG. 4;

FIG. 6 is an assembled sectional view of the step motor of FIG. 4;

FIG. 7 is a sectional view taken along line VII-VII of FIG. 6; and

FIG. 8 is a sectional view taken along line VIII-VIII of FIG. 6.

### DETAILED DESCRIPTION OF THE PREFERRED EMBODIMENT

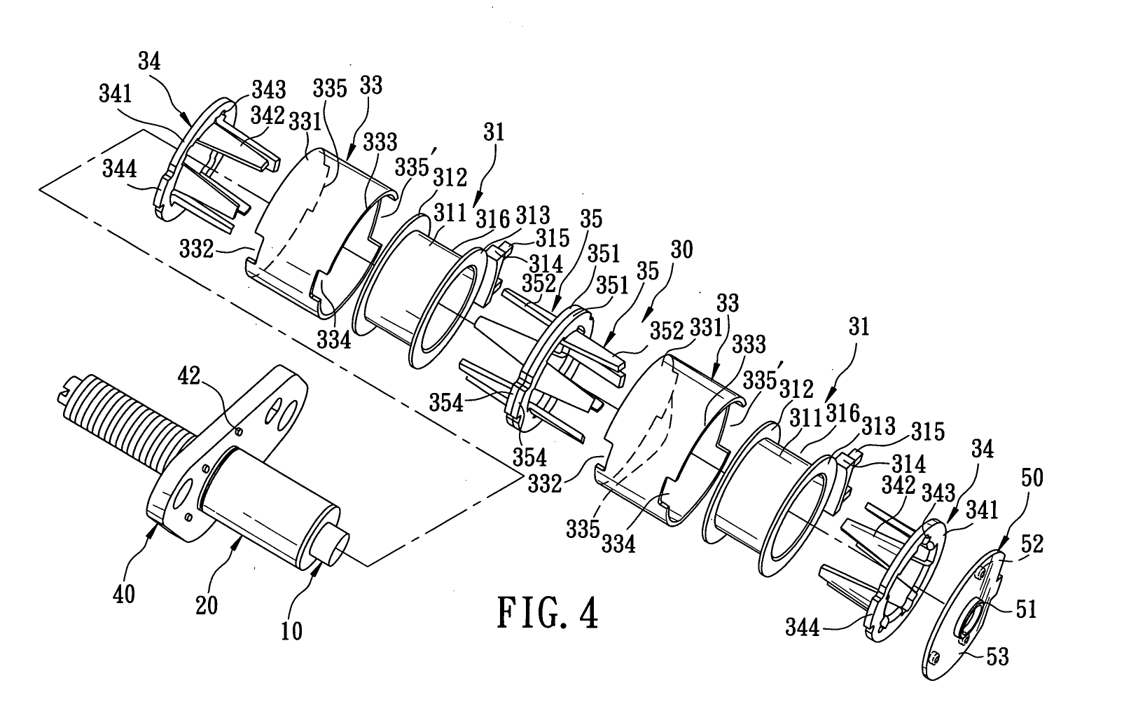

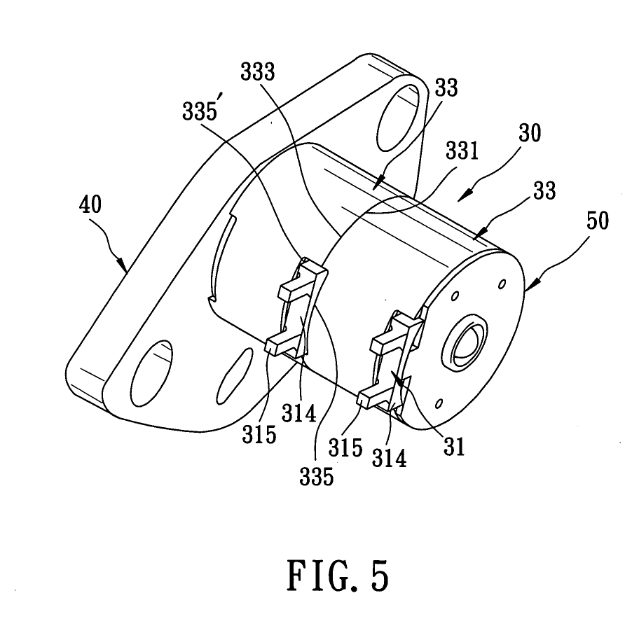

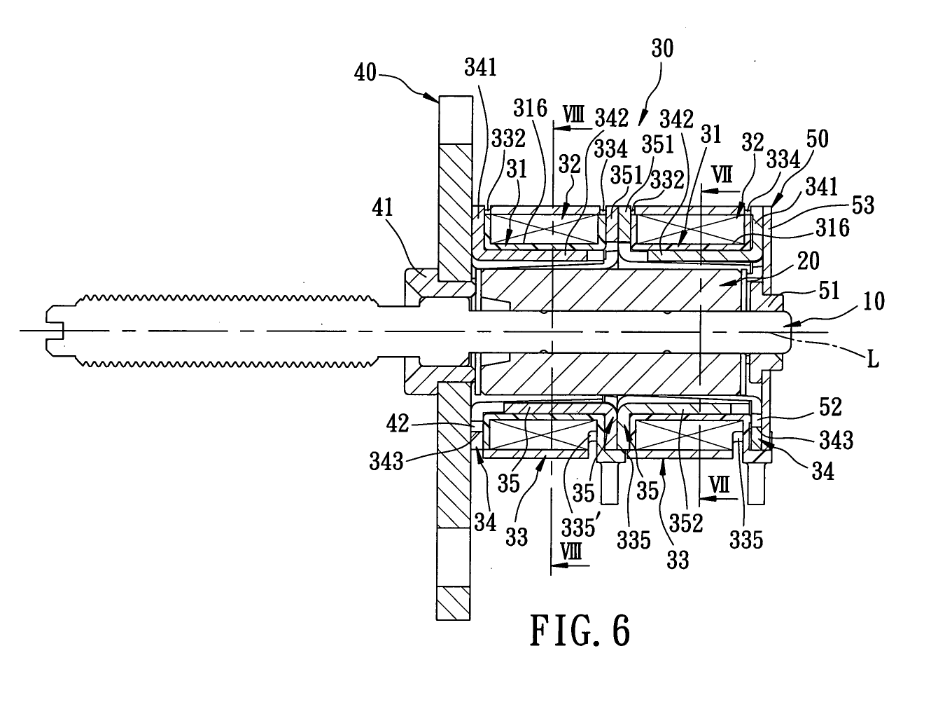

Referring to FIGS. 4, 5, and 6, a step motor with a stator having a separated structure according to a preferred embodiment of the present invention includes a spindle 10, a magnet unit 20 mounted around the spindle 10, a stator assembly 30 sleeved over the magnet unit 20 and having opposite ends, a fixing plate 40 secured to one of the ends of the stator assembly 30, and a cover unit 50 secured to the other one of the ends of the stator assembly 30.

The spindle 10 is formed as a cylindrical shaft, and extends along a motor axis (L).

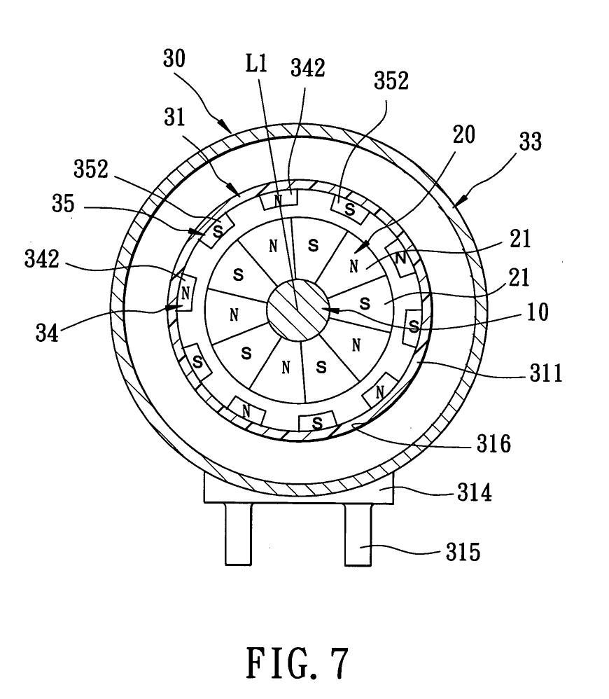

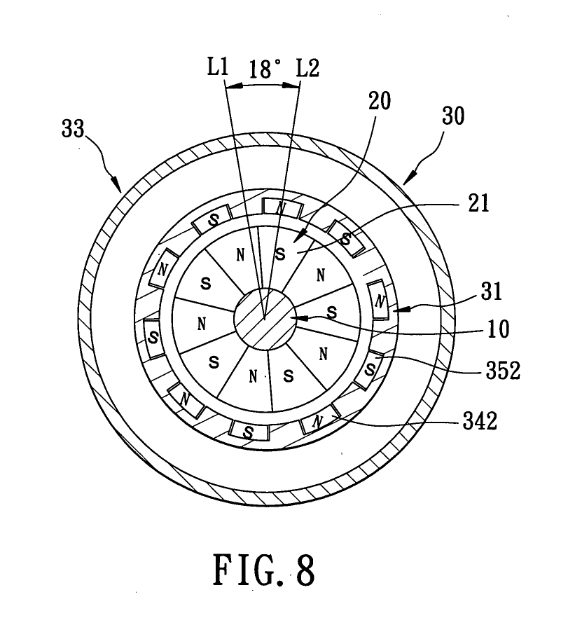

The magnet unit 20, with reference to FIGS. 7 and 8, includes a plurality of magnets 21 interlocked around the spindle 10 to thereby surround the motor axis (L). The magnets 21 are mounted such that their poles are alternating.

The stator assembly 30 includes at least one coil-and-yoke unit having a coil support 31 arranged along the motor axis (L) and with an inner end and an outer end, a coil 32 wound around the coil support 31, an outer tube 33 sleeved over the coil support 31 and the coil 32 wound therearound, a first magnetic yoke 34 inserted into the coil support 31 from the outer end thereof, and a second magnetic yoke 35 inserted into the coil support 31 from the inner end thereof. In the preferred embodiment, the stator assembly 30 includes a pair of the coil-and-yoke units. When needed for clarity, “upper” and “lower” will be used below to designate the elements respectively of the two coil-and-yoke units.

Each of the pair of the coil supports 31 resulting from having the pair of the coil-and-yoke units is hollow and generally cylindrical in shape. Each of the coil supports 31 includes a surrounding wall 311 formed surrounding the motor axis (L), and having an upper end and a lower end, a first flange 312 extending outwardly from the upper end of the surrounding wall 311, a second flange 313 extending outwardly from the lower end of the surrounding wall 311, a positioning tab 314 extending outwardly from the second flange 313, and a pair of conductive pin contacts 315 mounted on the positioning tab 314 and coupled electrically to the coil 32. The surrounding wall 311 and the first and second flanges 312, 313 of each of the coil supports 31 cooperate to define a coil groove 316 there among, and the respective one of the coils 32 is positioned in the coil groove 316.

Each of the outer tubes 33 includes a first end portion 331 corresponding in location to the first flange 312 of the respective coil support 31, a first catch notch 332 formed in the first end portion 331, a second end portion 333 formed opposite to the first end portion 331 and corresponding in location to the second flange 313 of the respective coil support 31, a second catch notch 334 formed in the second end portion 333, and positioning notches 335, 335′ formed respectively in the first and second end portions 331, 333 in sides thereof diametrically opposite respectively to the first and second catch notches 332, 334. For each of the outer tubes 33, the first and second catch notches 332, 334 are substantially aligned along a direction parallel to the motor axis (L), as are the positioning notches 335, 335′. When the pair of the outer tubes 33 are in an abutting state, the positioning notch 335′ of the upper outer tube 33 is aligned with the positioning notch 335 of the lower outer tube 33, and the positioning tab 314 of the upper coil support 31 is positioned within a space formed by the aligned notches 335, 335′. The positioning tab 314 of the lower coil support 31 is located within the positioning notch 335′ of the lower outer tube 33. As a result of this configuration, the outer tubes 33 and the coil supports 31 are securely positioned along a circumferential direction of the stator, as well as along the direction of the motor axis (L). Further, by welding the second end portion 333 of the upper outer tube 33 to the first end portion 331 of the lower outer tube 33, the outer tubes 33 may be fixed securely to one another. Each of the first magnetic yokes 34 includes a first annular segment 341, and a plurality of first excitation fingers 342 extending generally parallel to the motor axis (L) from an inner periphery of the first annular segment 341. The first annular segment 341 of each of the first magnetic yokes 34 includes a plurality of indentations 343 formed in the inner periphery thereof, and a first orientation fixing member 344 extending from an outer periphery thereof for insertion into either the first catch notch 332 or the second catch notch 334 of the corresponding one of the outer tubes 33. The first excitation fingers 342 are formed as tapered plates, and are inserted into the surrounding wall 311 of the corresponding coil support 31. In the preferred embodiment, each of the first magnetic yokes 34 includes five of the first excitation fingers 342. Each of the second magnetic yokes 35 includes a second annular segment 351, and a plurality of second excitation fingers 352 extending generally parallel to the motor axis (L) from an inner periphery of the second annular segment 351. The second annular segment 351 of each of the second magnetic yokes 35 includes a second orientation fixing member 354 extending from an outer periphery thereof for insertion into either the first catch notch 332 or the second catch notch 334 of the corresponding one of the outer tubes 33. The second excitation fingers 352 are formed as tapered plates, and are inserted into the surrounding wall 311 of the corresponding coil support 31 to be interdigitated with the first excitation fingers 342 of the corresponding one of the first magnetic yokes 34. In the preferred embodiment, each of the second magnetic yokes 35 includes five of the second excitation fingers 352.

With reference to FIGS. 7 and 8, for each of the coil supports 31, the five first and second excitation fingers 342, 352 of each of the first and second magnetic yokes 34, 35 are interdigitated in an alternating configuration, and are angularly spaced apart at approximately equal angles (i.e., 36 degrees in the case of five of each of the first and second excitation fingers 342, 352). Further, so that the step angle may be made smaller, the first and second excitation fingers 342, 352 of one pair of the first and second magnetic yokes 34, 35 mounted in one of the coil supports 31 are staggered at a predetermined angle of 18 degrees with respect to the first and second excitation fingers 342, 352 of the pair of the first and second magnetic yokes 34, 35 of the other one of the coil supports 31. This configuration can be seen by viewing FIGS. 7 and 8 in combination. As shown in FIG. 7, a radial line (L1) is drawn through a center one of the first and second excitation fingers 342, 352 of the lower coil support 31, and, as shown in FIG. 8, a radial line (L2) is drawn through a center of a circumferentially adjacent one of the first and second excitation fingers 342, 352 of the upper coil support 31. The angular distance between the radial lines (L1, L2) relative to the motor axis (L) is approximately 18 degrees as indicated in FIG. 8.

The fixing plate 40 may be secured to the upper outer tube 33 by welding. The fixing plate 40 includes an inner cover 41 in which the spindle 10 is journalled to be thereby interposed between the spindle 10 and the remainder of the fixing plate 40, and a plurality of first protuberances 42 extending from an inner surface of the fixing plate 40. The first protuberances 42 are positioned respectively in the indentations 343 of the respective one of the first magnetic yokes 34.

The cover unit 50 is fixed to the lower outer tube 33. An end portion of the spindle 10 is journalled in the cover unit 50. The cover unit 50 may be fixed to the corresponding outer tube 33 by welding. The cover unit 50 includes a bottom plate 53 having a hollow center portion, a sleeve 51 mounted in the hollow center portion of the bottom plate 53 and in which the spindle 10 is journalled, and a plurality of second protuberances 52 extending from an inner surface of the bottom plate 53. The second protuberances 52 are positioned respectively in the indentations 343 of the lower first magnetic yoke 34.

To assemble the step motor, the coils 32 are first wound around the coil grooves 316 of the coil supports 31, respectively, then the coil supports 31 are inserted respectively in the outer tubes 33. Next, the first and second excitation fingers 342, 352 of the first and second magnetic yokes 34, 35 are inserted into the coil supports 31 as described above. At this time, the first and second orientation fixing members 344, 354 are engaged with the first and second catch notches 332, 334, thereby securing the positions of the first and second magnetic yokes 34, 35 in the circumferential direction and along the direction of the motor axis (L). As a result, the first and second annular segments 341, 351 of the first and second magnetic yokes 34, 35 are positioned corresponding in location to the first and second flanges 312, 313 as described above.

During insertion of the coil supports 31 in the outer tubes 33, the positioning tabs 314 of the coil supports 31 are positioned within the notches 335, 335′. Further, the first end portion 331 of the lower outer tube 33 is welded to the second end portion 333 of the upper outer tube 33 to thereby fix the interlocked positioning of the first and second excitation fingers 342, 352 of the coil supports 31 at the predetermined phase angle as described above. Subsequently, the spindle 10 and the magnet unit 20 are positioned within the stator assembly 30, then the first and second protuberances 42, 52 are positioned in the indentations 343 of the first magnetic yokes 34, thereby completing assembly of the step motor.

Following assembly, the first and second excitation fingers 342, 352 of the first and second magnetic yokes 34, 35 positioned in the coil supports 31 are provided angularly spaced apart as described above, with the first and second excitation fingers 342, 352 between the two coil supports 31 being provided at the predetermined phase angle.

The present invention has the following advantages:

1. The first and second magnetic yokes 34, 35, the coil supports 31, and the outer tubes 33 are all provided in a separated configuration. As a result, manufacture of the first and second magnetic yokes 34, 35 is easy, and assembly of the first and second magnetic yokes 34, 35, the coil supports 31, and the outer tubes 33 does not involve a molding process. Manufacturing costs are reduced as a result.

2. The first and second magnetic yokes 34, 35 are independently mounted. Therefore, the manufacturing processes associated with the first and second excitation fingers 342, 352 are made simpler. Further, following manufacture, finishing processes to control a ratio between cross-sectional areas and lengths of the first and second excitation fingers 342, 352 may be accurately and easily performed, thereby enhancing a magnetic excitation effect and reducing production costs.

3. Using the configuration in which the first and second orientation fixing members 344, 354 of the first and second magnetic yokes 34, 35 are engaged with the first and second catch notches 332, 334 of the coil supports 31 such that the first and second excitation fingers 342, 352 are positioned in the coil supports 31 as described above, the first and second magnetic yokes 34, 35 are secured in position in the circumferential direction. Further, using precision in the placement of the coil supports 31 relative to one another, the first and second excitation fingers 342, 352 for each of and between the two coil supports 31 are uniformly distributed. Hence, step precision is ensured in the present invention. Finally, by engagement of the positioning tabs 314 of the coil supports 31 with the notches 335, 335′ of the outer tubes 33, rotation of the coil supports 31 relative to the outer tubes 33 is prevented, thereby further enhancing step precision. While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A step motor, comprising:
a spindle that extends along a motor axis;
a magnet unit mounted around said spindle;
a stator assembly sleeved over said magnet unit and having opposite ends, and including at least one coil-and-yoke unit having a coil support, a coil wound around said coil support, an outer tube sleeved over said coil, and a pair of magnetic yokes mounted in said coil support;
a fixing plate mounted to one of said ends of said stator assembly, and in which said spindle is journalled; and
a cover unit mounted to the other one of said ends of said stator assembly opposite to said fixing plate, and in which an end portion of said spindle is journalled;
wherein said coil support includes a surrounding wall surrounding said motor axis, and a positioning tab protruding outwardly from said surrounding wall;
wherein said outer tube includes first and second end portions, first and second catch notches formed respectively in said first and second end portions, and a positioning notch formed in one of said first and second end portions to engage said positioning tab of said coil support; and
wherein each of said magnetic yokes includes an orientation fixing member, and a plurality of excitation fingers inserted into said surrounding wall of said coil support, said orientation fixing member of each of said magnetic yokes engaging a respective one of said first and second catch notches, said excitation fingers of said magnetic yokes being uniformly distributed about said motor axis.

2. The step motor of claim 1, wherein said excitation fingers of one of said magnetic yokes are interdigitated with and are angularly spaced apart at equal intervals relative to said motor axis from said excitation fingers of the other one of said magnetic yokes in said coil support.

3. The step motor of claim 2, wherein said stator assembly includes a pair of said coil-and-yoke units, said excitation fingers of one of said coil supports being angularly spaced apart at equal intervals relative to said motor axis from said excitation fingers of the other one of said coil supports, each of said equal intervals corresponding to a predetermined phase angle, said outer tubes being fixedly interconnected.

4. The step motor of claim 1, wherein each of said magnetic yokes further includes an annular segment having an inner periphery and an outer periphery, a plurality of indentations being formed in said inner periphery, each of said fixing plate and said cover unit including a plurality protuberances that are engaged respectively with said indentations of the respective one of said magnetic yokes.

5. The step motor of claim 4, wherein said excitation fingers extend from one of said inner and outer peripheries of said annular segment parallel to said motor axis.

6. The step motor of claim 1, wherein said coil support further includes a conductive pin contact mounted on said positioning tab and connected electrically to said coil.

7. The step motor of claim 6, wherein said surrounding wall of said coil support is cylindrical in shape and has two ends, said coil support including a pair of flanges extending outwardly and respectively from said two ends of said surrounding wall, said positioning tab protruding outwardly from one of said flanges.

8. The step motor of claim 7, wherein said stator assembly includes a pair of said coil-and-yoke units, each of said outer tubes including a pair of said positioning notches, one of said positioning notches of one of said outer tubes corresponding in location to one of said positioning notches of the other one of said outer tubes to thereby define a space, said positioning tab of one of said coil supports engaging said space.

9. The step motor of claim 7, wherein said surrounding wall and said flanges cooperate to define a coil groove, said coil being disposed in said coil groove.

10. The step motor of claim 7, wherein each of said magnetic yokes further includes an annular segment having an inner periphery and an outer periphery, said excitation fingers extending from one of said inner and outer peripheries of said annular segment parallel to said motor axis, said annular segment of each of said magnetic yokes corresponding in location to a respective one of said flanges of said coil support.
